(19) United States
(12) Patent Application Publication
(10) Pub. No.: US 2003/0034478 A1
(43) Pub. Date: Feb. 20, 2003

(54) Deicing

(75) Inventors: Mark E. Stanley, Wexford, PA (US); Kevin W. Smith, McMurray, PA (US)

Correspondence Address: William L. Krayer, 1771 Helen Drive, Pittsburgh, PA, 15216, US

(73) Assignee: Clearwater, Inc.

(21) Appl. No.: 10/201,464

(22) Filed: Jul. 23, 2002

Related U.S. Application Data
(60) Provisional application No. 60/308,896, filed on Jul. 31, 2001.
(60) Provisional application No. 60/315,193, filed on Aug. 27, 2001.

(51) Int. Cl. C09K 3/18

(52) U.S. Cl. 252/70

(57) ABSTRACT

Alkanolamine formates are used as deicers, preferably accompanied by potassium formate. Preferred is triethanolamine formate, but the amine portion may be mono-, di- or triethanolamine or may be other, further alkoxylated amines. Tht compositions and methods are suggested for aircraft deicing.

### RELATED APPLICATIONS

This application claims the full benefit of Provisional Application No. 60/308,896 filed Jul. 31, 2001 and Provisional Application No. 60/315,193 filed Aug. 27, 2001.

### TECHNICAL FIELD

Compositions and methods are disclosed for deicing aircraft and airfield runways and ramps. Triethanolamine formate is used, alone or with more conventional deicing compounds and/or together with potassium formate.

### BACKGROUND OF THE INVENTION

Much effort and expense is devoted annually to removing ice from the wings of airplanes, where it is especially dangerous. Typically, after the loaded passenger plane has moved from its gate, it is detoured to a specially designed deicing site, where it is sprayed copiously with a heated aqueous solution of ethylene glycol, perhaps 42%, or propylene glycol, usually 50% by weight, until the pilot perceives no sign of ice on the wings. If the procedure is conducted during precipitation, a second composition may be applied, this one including a high percentage of glycol and a viscosifier to encourage a film to remain on the wings to impart a lower freeze point for any further precipitation that may land on the wing surface. The solutions are not diluted much by the melting ice and snow, and are permitted to fall on the apron, tarmac or runway and further into drains leading to storage pits or other containment areas. In the drains and storage pits, however, they are subject to continual dilution and the accumulation of dirt, making them more difficult to concentrate for reuse.

Patented compositions and methods previously suggested for aircraft deicing may be found in U.S. Pat. Nos. 4,954,279, 5,334,323, 5,759,436, and 5,935,488.

In U.S. Pat. No. 5,132,035 to Hoenke et al, calcium magnesium acetate is combined with a chelating agent to obtain a proposed deicing formulation. Smith, in U.S. Pat. No. 5,064,551, combines an alkali metal carboxylate with an alkali metal phosphate and an alkali metal nitrate. Stankowiak et al use combinations of alkali metal acetate or formate with a nitrate and a silicate. Hydroxycarboxylic compounds are used optionally with a formate by Sapienza in U.S. Pat. No. 6,129,857. Peel combines acetates and formates with lactates, in U.S. Pat. No. 4,746,449.

Solutions containing glycols are environmentally undesirable, recycling is difficult, and disposal is problematical. Contamination into storm drainage may result in revocation of storm water drain permits. A more efficient method of deicing airplane wings is needed, preferably one which does not generate large quantities of environmentally objectionable solution.

In addition to the environmental problems, conventional techniques for wing deicing are time-consuming and can result in cascading delays in whole systems and networks of airports, even where there is no ice problem, because of delays in arrivals from airports where deicing is a necessity. Some of the time is consumed simply in queues to get to the deicing stations, some by the relatively slow action of the deicing fluid, and some by the application of a residual film of anti-icing fluid to the wings to prevent new ice and snow buildup.

Triethanolamine formate has been used as a dispersing agent (U.S. Pat. No. 6,213,415), to inhibit gel formation in liquid detergent compositions (U.S. Pat. No. 4,079,078), and suggested by Rosenberg et al in U.S. Pat. No. 4,355,079 as a “water reducing agent” in a corrosion inhibiting film.

### SUMMARY OF THE INVENTION

We have invented a composition and method for deicing airplane wings. While they are particularly useful for airplane wings or in other contexts in which it is desired to use an aqueous solution, our compositions and methods may be used in any context to melt ice and snow, or to inhibit ice formation or buildup, or to reduce the freezing point of water.

Our preferred composition comprises triethanolamine formate and potassium formate, preferably in an aqueous solution. Preferably the solution contains triethanolamine formate (hereafter referred to as TEAF) in a concentration of at least 10% by weight and potassium formate in a concentration of at least 10% by weight. In another aspect, our invention includes the use of an effective amount of an aqueous solution of TEAF and potassium formate in a molar ratio of 4:1 to 1:4, more preferably 1:2 to 2:1, the total concentration of TEAF and potassium formate being at least 10% by weight. We prefer to use combinations of TEAF and potassium formate in molar ratios of 1:4 to 4:1, with total solids from 20% to 75% by weight. Our most preferred composition can be made by adding (A) an aqueous solution of potassium formate (70% by weight) to an equal amount (by weight, including the water), of (B) the product formed by mixing 38.7% triethanolamine (99% active) and 12.1% formic acid (98% active) in 49.2% water. Preferably component (B) comprises the reaction product of molar equivalents of triethanolamine and formic acid, and has the formula (HOCH₂CH₂)₃NH⁺HCOO⁻ in water. The triethanolamine may be added first to water; then the formic acid is added slowly to control the exotherm from the neutralization between the acid and the amine. The solution becomes transparent after mixing for a few hours.

Definition: We use the term “triethanolamine formate” to mean any of (a) a mixture of 1 mole of triethanolamine and one mole of formic acid, (b) a mixture of triethanolamine and formic acid in a molar ratio of 1:4 to 4:1, (c) a composition of the formula (HOCH₂CH₂)₃NH⁺HCOO⁻, or (d) a combination of (a) or (b) with (c) in a weight ratio of up to 100:1

Our invention includes mixtures of triethanolamine formate and potassium formate and their use as deicers. Monoethanolamine formate and diethanolamine formate may be substituted for triethanolamine formate in any context mentioned herein. That is, our invention includes the use as deicers or freeze point derpessants formates of the formula (OHCH₂CH₂)_{X}N⁺H_{(4-X)}.HCOO⁻, where x is a number from 1 to 3. Our invention is also compatible with compositions wherein other alkali metal formates, i.e. sodium formate, are used instead of potassium formate, or other carboxylic acids, i.e. acetic acid, are used instead of formic acid in the manufacture of the carboxylic acid salt of the mono-, di-, or triethanolamine. These may be quite suitable in some contexts, but our composition invention comprises the ethanolamine formates as described herein together with potassium formate. Our invention includes the use of any mono- di- or triethanolamine formate by itself or in water in an amount effective to inhibit the formation of ice, or to lower the freeze point of solid or liquid water.

In another aspect, our invention includes the use as deicers alkoxylated amine formates of the formula [H{O(CH₂)_{Z}}_{Y}]_{X}N⁺H_{(4-X)}HCOO⁻ where each Z is independently selected from 2 and 3, each Y is independently selected from integers from 1 to 20, and X is a number from 1 to 3. Such alkoxylated amine formates will tend to be somewhat more viscous than mono-, di-, or triethanolamine formates and accordingly may tend to obviate the use of viscosifiers to help the solution to cling to the wing surface during precipitation while the plane is on the ground.

Our invention therefore includes the use as a deicer of a composition as described above wherein the product described in (B) is triethanolamine formate; it includes the use of any combination of triethanolamine and formic acid, in water, that results in triethanolamine formate as above defined. The triethanolamine formate may be combined with potassium formate to provide excellent deicing results. The triethanolamine formate and potassium formate solution may be used in any effective proportions and effective amounts but is preferably used in a weight ratio of 4:1 to 1:10, more preferably in a weight ratio within the range of 1:1 to 1:6 in an aqueous solution of at least 10% by weight, or, more preferably, a total concentration of 15-75% by weight. Preferably the triethanolamine formate/potassium formate solution used for spraying will have a pH of 7-8.5 but any pH may be used where it is determined that any adverse effect caused by pH can be tolerated.

Our composition may be applied to aircraft wings by spraying, either heated or not, and can be applied after the ice and snow is removed, to prevent further accumulation of ice and snow. Because it is environmentally benign, our solution can be applied anywhere in the airport, thus eliminating the necessity of waiting for a turn at a special deicing station equipped with environmentally dictated recovery facilities. Tank trucks and spray equipment can be available at numerous sites in the airport and/or from otherwise mobile equipment, thus drastically reducing the delay times caused by deicing.

### BRIEF DESCRIPTION OF THE DRAWINGS

FIG. 1 is a plot of water freeze points containing various concentrations of triethanolamine formate.

FIG. 2 is a plot of freeze points of water containing various concentrations of potassium formate in a solution of triethanolamine formate.

### DETAILED DESCRIPTION OF THE INVENTION

Our invention includes (1) an aqueous deicing solution including potassium formate and triethanolamine formate in a weight ratio ranging from 0:1 to 10:1, in any effective amount, preferably in a total concentration of at least 10 weight percent in water, and (2) a method of deicing aircraft comprising applying our aqueous deicing solution to the surfaces of an aircraft, preferably by spraying. Our invention includes the use of triethanolamine formate as a deicer, whether or not there is potassium formate present, with or without other compositions. Possible other compositions that could be included with triethanolamine formate include potassium acetate, sodium acetate, sodium formate, and alkali metal and alkaline earth metal salts such as salts of organic acids having from 2-10 carbon atoms, other known ice melting compounds such as lithium chloride, potassium chloride, urea, ammonium chloride, alkali metal bromides and other halides, ethylene glycol, propylene glycol, diethylene glycol dipropylene glycol, and various other glycols known to reduce the freeze point of water under various conditions. Triethanolamine formate and/or our triethanolamine formate/potassium formate combination may be combined with any of the compositions proposed for the reduction of the freeze point of water in any of the patents identified in the Background of the Invention, which are hereby incorporated by reference. Generally, however, one will want to use combinations which will present a low biological oxygen demand (BOD). A clear advantage of our compositions is that they are environmentally acceptable and in many cases will not require capture and recycling. Additives which are environmentally undesirable and/or which should be captured and/or recycled are therefore not recommended for combination with our compositions; however, it is to be noted that corrosion inhibitors, for example, which are known to be beneficial for aluminum aircraft surfaces may be used as well as other known corrosion inhibitors. Viscosifiers may also be combined with our compositions to facilitate adherence of the composition to wings and other surfaces during precipitation.

Corrosion inhibitors which may be used with our compositions and in our methods include tolytriazole, benzotriazole, alkoxylated butynediol, thiourea, propargyl alcohol, sodium nitrate, butyne 1-4 diol, alkali metal succinates, sodium polyaspartate, alkali metal sebacates, alkali metal salts of fatty acids, mono and dialkyl amines, phosphate and phosphonate esters, and sodium nitrate. Typically the corrosion inhibitor will be used in a concentration in solution of 0.1 ppm to 1 percent by weight.

Useful thickeners and viscosifiers include numerous water-soluble polymers such as the natural gums guar and xanthan and their derivatives, polysaccharides and polygalactomannans, various celluloses and starches and their derivatives and synthetic water-soluble polymers, crosslinked or not, such as polyacrylamide and copolymers of acrylamide with other monomers. Such polymeric compositions vary considerably in molecular weight and viscosifying effect; generally any amount effective for the desired purpose of causing the solution to cling to the aircraft surface for a desired time is suitable, i.e. from 0.01 percent by weight to two percent by weight. Normally one would not want the solution to be so viscous as to be difficult to spray or pump.

Our deicing method includes spraying an aircraft surface with an aqueous solution of triethanolamine formate and/or with an aqueous solution of triethanolamine formate and potassium formate. The solution may be heated, for example, to 180° F. Where ice is already present, heating the solution will accelerate the melting of the ice, permitting the TEAF solution to maintain a low freeze point in whatever resultant diluted treating solution remains on the airplane wing or other surface. Preferably the solution will be capable of reducing the freeze point of water to −50° F. or lower.

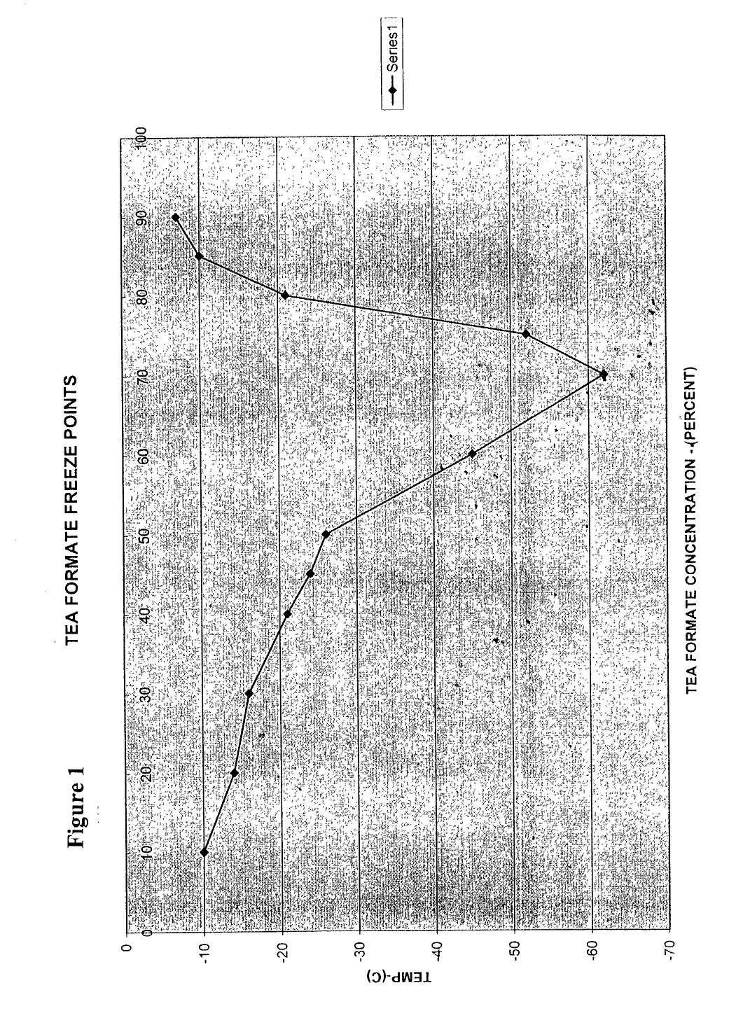

FIG. 1 shows that triethanolamine formate in concentrations of 50-75% achieves quite low freeze points. While concentrations higher than 75% have considerably higher freeze points and are therefore initially apparently undesirable, it should be noted that any water present from melting ice or other sources will tend to dilute the solution to bring it into the highly effective range of 60-75%. The use of initial concentrations higher than 75% is therefore included in our invention. An especially practical and preferred range of TEAF for airport use is 40-75% by weight.

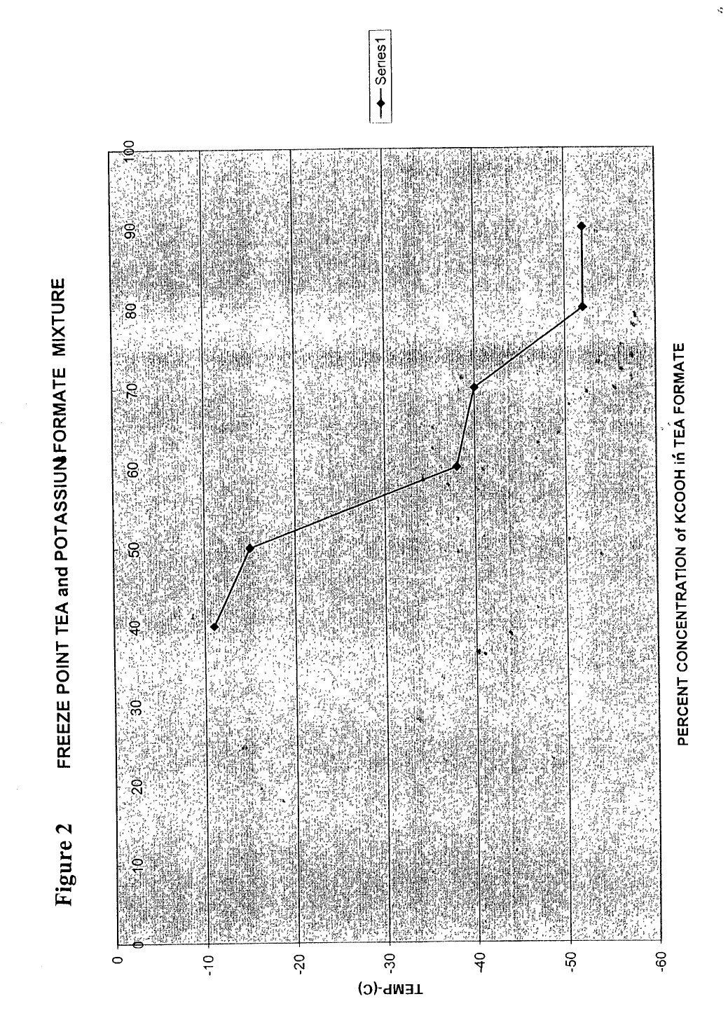

FIG. 2 likewise demonstrates the freeze point lowering abilities of a combination of triethanolamine formate and potassium formate. The term “Percent Concentration of KCOOH in TEA Formate” means the percentage, by weight, of a 70% active solution of potassium formate in a total solution made by combining it with an 89% active solution of triethanolamine formate. The data point at 60%, for example, represents a solution comprising, by weight, (a) 60% KCOOH, 70% active in water, and (b) 40% triethanolamine formate, 89% active in water. The graph shows that the addition of KCOOH to the TEAF extends considerably the freeze point reducing effects of TEAF over a useful range of ratios. An especially practical and preferred range of combinations of TEAF and potassium formate is a molar ratio of TEAF to KCOOH of 1:4 to 4:1, in concentrations of (the total of TEAF and KCOOH in terms of solids) of 10% to 80%, preferably 20% to 75% by weight. Preferably the solution will have a freeze point of −50° F. or lower.

In Table 1, corrosion data are shown for compositions within our invention. The results are accelerated corrosion tests conducted in a Rohrback model 9030 “Corrater” made by Cosasco Systems at 88° C., in which the specimen is used as an electrode to determine the “linear polarization resistance,” or LPR. A standard corrosive solution was used, comprising 148 mg/L sodium sulfate, 165 mg/L sodium chloride, and 138 mg/L sodium bicarbonate. Results are determined from weight loss converted to mils/year by dividing the weight loss in the specimen by its area modified by the metal density and the time in the Corrater.

TABLE 1
Corrater Predicted Corrosion Rates in mils/year
All solutions in 1/3 dionized water

| Solution | pH | Electrode | Initial | 16 hrs | 24 hours | 40 hours |
|---|---|---|---|---|---|---|
| TEAF | 6.56 | AL2024 | 0.25 | 1.5 | 2 | 1.9 |
| TEAF/KF | 7.78 | AL2024 | 0.47 | 0.5 | 0.4 | 0.4 |
| TEAF | 9 | AL2024 | 0.12 | 0.12 | 0.12 | 0.13 |
| TEAF/KF | 9 | AL2024 | 2.9 | 1.1 | 1.1 | 0.29 |
| TEAF | 9 | 1010C | 0.07 | 14 | 14 | 6 |
| TEAF/KF | 9 | 1010C | 0.08 | 2 | 2.1 | 2 |

Key:
TEAF: A 50% solution of triethanolamine formate (made from 1:1 molar triethanolamine and formic acid
TEAF/KF A 50/50 by weight blend of TEAF and a 70% solution of potassium formate
AL2024: Aircraft aluminum specimen
1010C: Carbon steel

1. A composition useful as a deicer and aqueous freeze point depressant comprising triethanolamine formate and potassium formate.

2. Composition of claim 1 in an aqueous solution.

3. Composition of claim 2 wherein said triethanolamine formate is present in a concentration of at least 10% by weight.

4. Composition of claim 2 wherein said triethanolamine formate and said potassium formate are present in a molar ratio of 1:4 to 4:1 and a total concentration of 10% to 80% by weight.

5. Method of inhibiting the formation of ice on a solid surface or removing ice from said solid surface comprising applying to said solid surface an effective amount of an amine formate of the formula [H{O(CH₂)_{Z}}_{Y}]_{X}N⁺H_{(4-X)}HCOO⁻ where each Z is independently selected from 2 and 3, each Y is independently selected from integers from 1 to 20, and X is a number from 1 to 3.

6. Method of claim 5 wherein said amine formate is of the formula (OHCH₂CH₂)_{X}N⁺H_{(4-X)}.HCOO⁻.

7. Method of claim 5 wherein said amine formate comprises triethanolamine formate in an aqueous solution including potassium formate.

8. Method of claim 7 wherein said triethanolamine formate and said potassium formate are present in a weight ratio of from 4:1 to 1:10 and a total concentration of at least 10% by weight.

9. Method of claim 7 wherein said solution comprises at least 10% by weight triethanolamine formate and at least 10% by weight potassium formate.

10. Method of claim 7 wherein said solid surface is an airplane wing.

11. Method of claim 7 wherein said triethanolamine formate and said potassium formate are present in a molar ratio of 1:1 to 1:6.

12. An airplane wing having a solution comprising triethanolamine formate thereon.

13. An airplane wing of claim 12 wherein said solution includes potassium formate.

14. An airplane wing of claim 12 wherein said solution has a freeze point lower than −50° F.

15. An airplane wing of claim 12 wherein said solution includes at least one of (a) an additional freeze point depressant, (b) a corrosion inhibitor, or (c) a viscosifier.

16. A composition of claim 1 wherein the composition includes at least one of (a) an additional freeze point depressant, (b) a corrosion inhibitor, or (c) a viscosifier.

17. A method of claim 6 wherein said solution includes at least one of (a) an additional freeze point depressant, (b) a corrosion inhibitor, or (c) a viscosifier.
